(19) United States
(12) Patent Application Publication
(10) Pub. No.: US 2007/0186122 A1
(43) Pub. Date: Aug. 9, 2007

(54) Information processing device, and suspending/resuming method of the same

(76) Inventors: Shuji Hori, Iruma-shi (JP); Toshitaka Sanada, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/654,567

(22) Filed: Jan. 18, 2007

(30) Foreign Application Priority Data
Jan. 20, 2006 (JP) 2006-012625

(51) Int. Cl. G06F 1/32

(52) U.S. Cl. 713/320

(57) ABSTRACT

According to one embodiment, an information processing device which is configured to execute suspending and resuming, the information processing device include a display controller which generates a video signal, a first storage unit in which a program to initialize the display controller is stored, a second storage unit which stores the program stored in the first storage unit during the suspending, and an executing section which executes the program stored in the second storage unit during the resuming.

### CROSS-REFERENCE TO RELATED APPLICATIONS

This application is based upon and claims the benefit of priority from Japanese Patent Application No. 2006-012625, filed Jan. 20, 2006, the entire contents of which are incorporated herein by reference.

### BACKGROUND

1. Field

One embodiment of the invention relates to an information processing device which can execute suspending and resuming, and a suspending/resuming method of the information processing device.

2. Description of the Related Art

A notebook-size personal computer or the like has a state referred to as a suspended state in which the computer is not used by a user at the moment but can quickly be used when the use of the computer is desired by the user again. To bring the computer into the suspended state, suspending is executed to store in a RAM, a hard disk drive or the like a state in which the user has used the computer. When the computer is reused, processing referred to as resuming is executed to resume a previous environment based on contents stored in the RAM, the hard disk drive or the like.

A start time of the resuming is one of specifications which are important for improvement of operability of the personal computer, and it is required that the start time be short (the computer should quickly start). In required specifications of a certain personal computer, it is specified that a resumption time of a BIOS should be within 250 milliseconds.

In Jpn. Pat. Appln. KOKAI Publication No. 2005-157748, a technology is disclosed in which a memory image is transferred from a nonvolatile memory to the RAM during the resuming to thereby shorten the start time of the resuming.

In the above technology, a time to transfer the memory image is required during the resuming (the starting). Therefore, it is demanded that a time of the resuming should further be shortened.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing one example of a schematic constitution including a personal computer as an information processing device according to one embodiment of the present invention and an external display;

FIG. 2 is an exemplary block diagram showing one example of a circuit constitution of the personal computer according to one embodiment of the present invention;

FIG. 3 is an exemplary diagram showing a constitution example of a VGA BIOS according to one embodiment of the present invention;

FIG. 4 is an exemplary flow chart showing a processing procedure during suspending according to one embodiment of the present invention;

FIG. 5 is an exemplary flow chart showing a processing procedure during resuming according to one embodiment of the present invention; and

FIG. 6 is an exemplary diagram showing comparison between a time required for resuming according to one embodiment of the present invention and a time required for resuming according to a conventional technology.

### DETAILED DESCRIPTION

Various embodiments according to the invention will be described hereinafter with reference to the accompanying drawings. In general, according to one embodiment of the invention, an information processing device which is configured to execute suspending and resuming, the information processing device comprises a display controller which generates a video signal, a first storage unit in which a program to initialize the display controller is stored, a second storage unit which stores the program stored in the first storage unit during the suspending, and an executing section which executes the program stored in the second storage unit during the resuming.

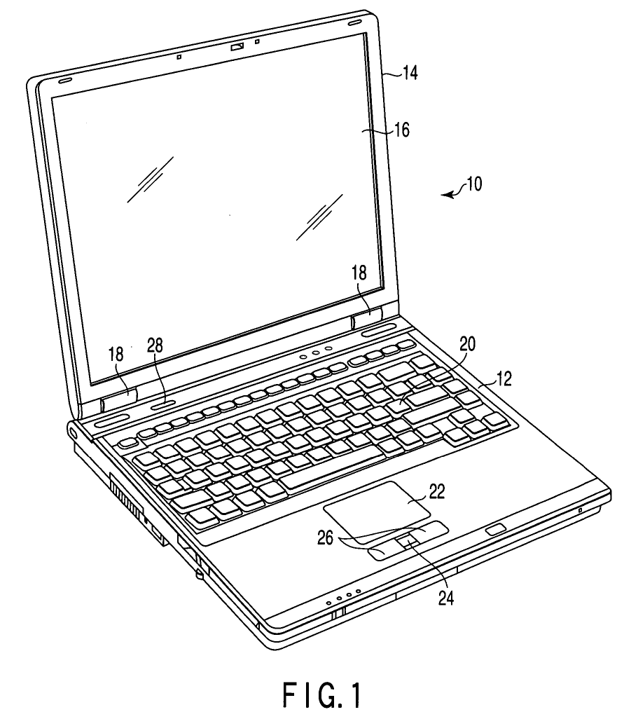

FIG. 1 is a diagram showing one example of a constitution of a notebook-size personal computer as an information processing device according to an embodiment of the present invention.

A personal computer 10 is constituted of a computer main body 12 and a display unit 14 as a display section. In the display unit 14, a liquid crystal display (LCD) 16 is incorporated which is a display panel.

The display unit 14 as the display section is attached to hinges (support portions) 18 disposed on a distal end of the computer main body 12 so that the display unit 14 is rotatable between an opened position where the upper surface of the computer main body 12 is exposed and a closed position where an upper surface of the computer main body 12 is covered.

The computer main body 12 has a thin box-shaped housing, and a keyboard 20 is disposed in the center of an upper surface of the housing. A palm rest is formed in the upper surface of a proximal housing portion of the computer main body 12. In a substantially central portion of the palm rest, a touchpad 22, a scroll button 24 and touchpad control buttons 26 are arranged. On an upper surface of a distal housing portion of the computer main body 12, a power button 28 is disposed to turn on/off a power source of the computer main body 12.

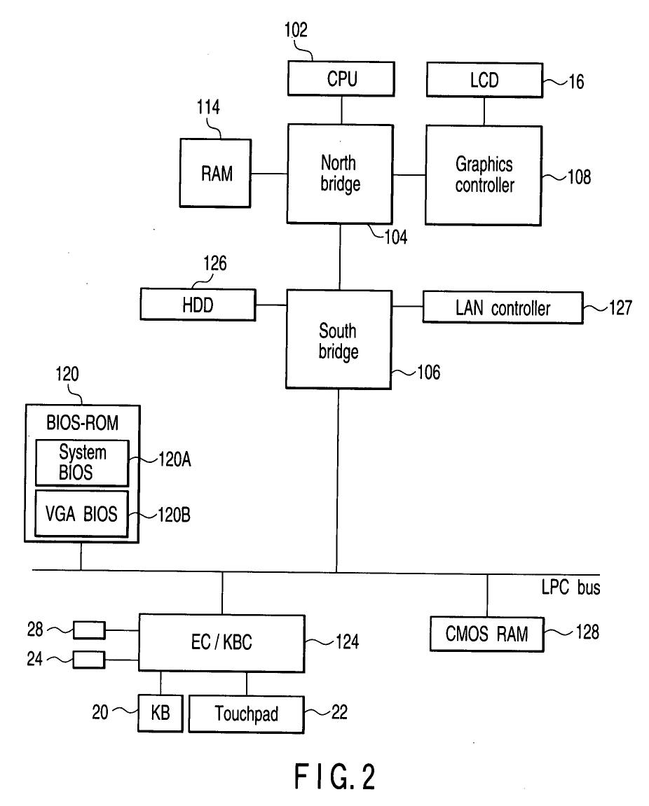

Next, one example of a system constitution of the present computer will be described with reference to FIG. 2.

As shown in FIG. 2, the present computer includes a CPU 102, a north bridge 104, a RAM 114 as a main memory (a second storage unit), a graphics controller 108 as output means, a south bridge 106, a BIOS-ROM 120, a hard disk drive (HDD) 126, an embedded controller/keyboard controller IC (EC/KBC) 124 and the like.

The CPU 102 is a processor disposed to control an operation of the present computer, and executes an operating system (OS) and various application programs loaded into the main memory 114 from the hard disk drive (HDD) 126.

Moreover, the CPU 102 loads, into the main memory 114, a basic input output system (BIOS) and a video graphics array basic input output system (VGA BIOS) stored in the BIOS-ROM 120 as a first storage unit, and then executes the systems. A system BIOS 120A is a program for hardware control. It is to be noted that an operation speed (reading speed) of the RAM 114 is higher than that of the BIOS-ROM 120.

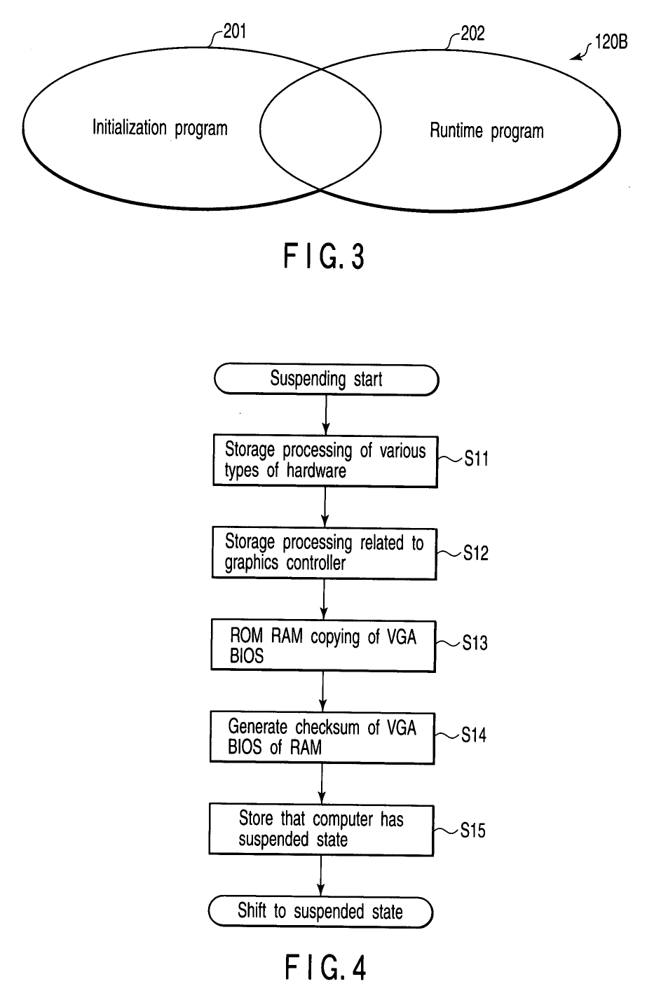

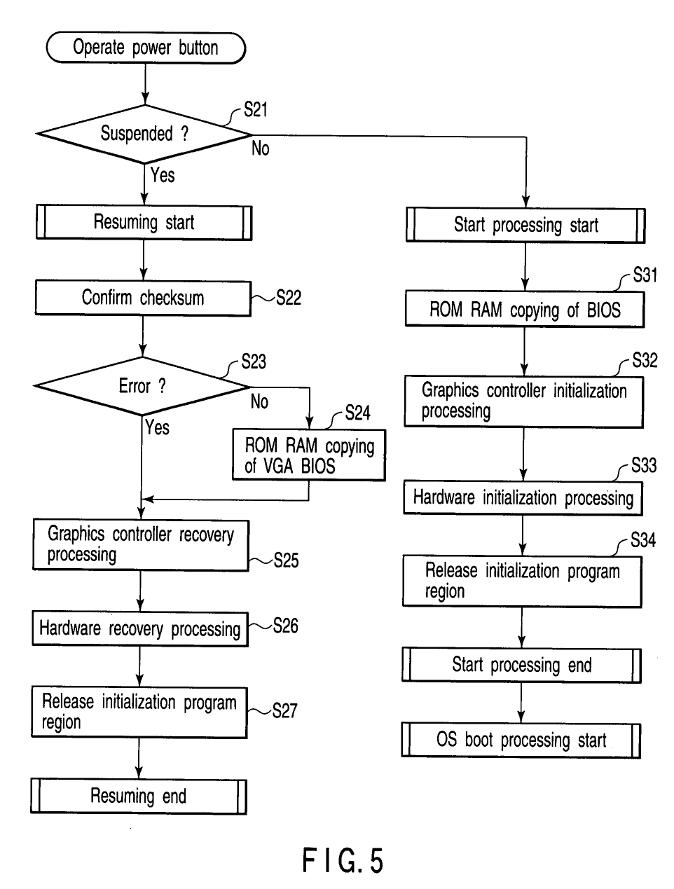

A VGA BIOS 120B is a program for controlling the graphics controller 108. As shown in FIG. 3, the VGA BIOS 120B has two programs of an initialization program 201 which initializes the graphics controller 108, and a run time program 202. To reduce a capacity of the BIOS-ROM 120, the two programs are stored in the BIOS-ROM 120 while sharing a part of components.

The north bridge 104 is a bridge device which connects a local bus of the CPU 102 to the south bridge 106. In the north bridge 104, a memory controller which accesses and controls the RAM 114 is also incorporated. The north bridge 104 also has a function of executing communication with the graphics controller 108 via an accelerated graphics port (AGP) bus or the like.

The graphics controller 108 is a display controller which controls the LCD 16 for use as a display monitor of the present computer. This graphics controller 108 has a video memory (VRAM), and generates a video signal which forms a display image to be displayed in the LCD 16 from display data drawn in the video memory in accordance with an OS/application program. The video signal generated by the graphics controller 108 is output to a line.

The south bridge 106 is connected to an LAN controller 127 which transfers data to an apparatus connected to a network via a PCI bus.

The embedded controller/keyboard controller IC 124 controls the touchpad 22, the scroll button 24 and the touchpad control buttons 26 as input means. The embedded controller/keyboard controller IC 124 is a single-chip microcomputer which monitors and controls various devices (peripherals, sensors, a power source circuit, etc.) regardless of a system state of the computer 10.

A complementary metal-oxide semiconductor random access memory (CMOS RAM) 128 stores set contents of the system BIOS 120A and information indicating whether or not the computer is in a suspended state, as necessary information during starting of the PC.

Next, a process to bring the computer into the suspended state will be described.

When a user operates the power button 28, the EC/KBC 124 notifies the system BIOS 120A that the power button has been operated. The system BIOS 120A executes processing to shift to the suspended state.

First, the system BIOS 120A stores, in the RAM 114, statuses of various hardware devices such as the LAN controller 127 (block S11). Subsequently, the system BIOS 120A sets a status of the graphics controller 108 and stores contents of the VRAM of the graphics controller 108 in the RAM 114 (block S12)

Subsequently, the system BIOS 120A executes such so-called ROM RAM copying as to write the compressed VGA BIOS 120B while developing the compressed VGA BIOS 120B in the RAM 114 (block S13). The run time program developed during the starting remains in the RAM 114, but is developed in the same region to overwrite the run time program originally present in the RAM 114 during the developing in block S13.

Next, the system BIOS 120A generates a checksum of a region of the VGA BIOS of the RAM 114, and stores the generated checksum in the RAM 114 (block S14). It is to be noted that the checksum does not have to be stored in the RAM 114 and may be stored in another storage unit such as the hard disk drive.

Subsequently, the system BIOS 120A stores information indicating that the computer has the suspended state in the CMOS RAM 128 (block S15). Next, when the suspending by the system BIOS 120A all ends, the computer 10 is brought into the suspended state. After the suspending, a power is supplied to the RAM 114 to retain the stored contents.

Next, a process during resuming will be described.

When the user operates the power button 28, the EC/KBC 124 notifies the CPU 102 that the power button has been operated. The CPU 102 executes the system BIOS in the RAM 114.

The CPU 102 refers to the information indicating whether or not the computer is in the suspended state in the CMOS RAM 128, and judges whether or not the computer 10 is in the suspended state (block S21).

When the computer is in the suspended state (Yes in block S21), the CPU 102 starts the resuming. First, the CPU 102 generates a checksum of a region of the VGA BIOS of the RAM 114 (block S22). The CPU 102 compares the checksum generated by the processing of block S22 with the checksum stored in the RAM 114 in block S14, and judges whether or not there is an error in the VGA BIOS 120B of the RAM 114 (block S23). The generation of the checksum and the comparison between the checksums are completed in one millisecond or less.

If it is judged that there is the error (No in block S23), the CPU 102 judges that the ROM/RAM-copied VGA BIOS in the RAM 114 is destroyed during the suspending or the resuming, and writes the compressed VGA BIOS 120B while developing the compressed VGA BIOS 120B in the RAM 114 (block S24).

If it is judged that there is no error (Yes in block S23) or after the processing of block S24, the CPU 102 executes the initialization program in the VGA BIOS of the RAM 114 to execute recovery (initialization) processing of the graphics controller (block S25). Subsequently, the contents of the VRAM stored in the RAM 114 are written back in the VRAM of the graphics controller 108. In the suspended state, no power is supplied to the graphics controller 108, and hence the recovery (initialization) processing is required during the resuming.

The CPU 102 executes recovery processing of various hardware devices other than the graphics controller 108 based on statuses of the devices stored in the RAM 114 (block S26).

The CPU 102 releases an initialization program region of the VGA BIOS of the RAM 114 (block S27). It is to be noted that this processing may be performed at any time after the recovery processing of the graphics controller 108 ends.

When the resuming of the system BIOS all ends, the computer 10 returns to a state before shifted to the suspended state.

In the processing of block S21, when it is judged that the computer is not suspended (No in block S21), the CPU 102 initiates start processing to initialize the various hardware devices. First, the CPU executes so-called ROM RAM copying to copy the system BIOS 120A and the VGA BIOS 120B of the BIOS-ROM 120 in the RAM 114 (block S31).

The CPU 102 executes the initialization program of the VGA BIOS of the RAM 114 to thereby initialize the graphics controller 108 (block S32). Subsequently, the CPU 102 executes the system BIOS, and executes the initialization processing of the hardware device (block S33). The CPU 102 releases the initialization program region of the VGA BIOS of the RAM 114 (block S34). It is to be noted that this processing may be performed at any time after the initialization processing of the graphics controller 108 ends. When the start processing ends, boot processing of the operating system (OS) is executed.

In required specifications of a certain personal computer, it is specified that a resuming recovery time of the BIOS should be set to 250 milliseconds or less. In a case where the VGA BIOS has a capacity of 64 kilobytes, about 40 milliseconds are required for the ROM RAM copying of the VGA BIOS, and hence there is a problem that this processing only occupies about 16% of 250 milliseconds of the required specifications.

In general, demand for the shortening of the processing time during the suspending (during the shift to the suspended state [at a time when a power supply is turned off]) is not so strong as compared with the case of the resuming (the starting). In the present embodiment, the ROM RAM copying of the VGA BIOS stored in the BIOS-ROM 120 is beforehand performed during the suspending, not during the resuming. Since the ROM RAM copying is executed during the suspending, the time required for the resuming can be shortened.

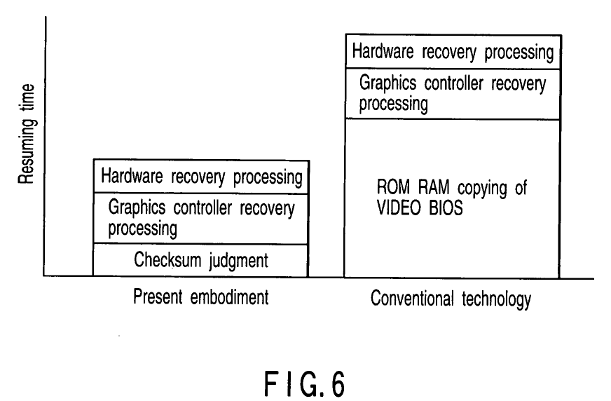

For example, FIG. 6 shows examples of the time required for the resuming in the present embodiment and a time required for conventional resuming. As shown in FIG. 6, the time required for the resuming in the present embodiment is shorter than that required for the conventional resuming. When the VGA BIOS has a capacity of 64 kilobytes, about 40 milliseconds are required for the ROM RAM copying of the VGA BIOS. However, in the present embodiment, instead of the ROM RAM copying of the VGA BIOS, the generation of the checksum (block S21) and the comparison between the checksums (block S22) are performed, but for the processing of these blocks, one millisecond or less is required. Therefore, for example, shortening of about 39 milliseconds can be achieved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device which is configured to execute suspending and resuming, the information processing device comprising:
a display controller which generates a video signal;
a first storage unit in which a program to initialize the display controller is stored;
a second storage unit which stores the program stored in the first storage unit during the suspending; and
an executing section which executes the program stored in the second storage unit during the resuming.

2. The information processing device according to claim 1, wherein an operation speed of the second storage unit is higher than that of the first storage unit.

3. The information processing device according to claim 1, further comprising:
a judgment section which judges during the resuming whether or not the program stored in the second storage unit has a problem,
the second storage unit being a storage unit which stores the program stored in the first storage unit during the resuming, when the judgment section judges that the program has the problem.

4. The information processing device according to claim 1, wherein the second storage unit is a storage unit which stores the program during start processing,
the information processing device further comprising:
a release section which releases a region of the second storage unit where the program is stored after the program stored in the second storage unit during the start processing is executed during the start processing.

5. An information processing device which is configured to execute suspending and resuming, the information processing device comprising:
a display controller which generates a video signal;
a first storage unit in which a program to initialize the display controller is stored;
a second storage unit to which a power is supplied even after the suspending and which stores the program stored in the first storage unit during the suspending; and
an executing section which executes the program stored in the second storage unit, when the resuming is executed after the suspending.

6. The information processing device according to claim 5, wherein an operation speed of the second storage unit is higher than that of the first storage unit.

7. The information processing device according to claim 5, further comprising:
a judgment section which judges during the resuming whether or not the program stored in the second storage unit has a problem,
the second storage unit being a storage unit which stores the program stored in the first storage unit during the resuming in a case where the judgment section judges that the program has the problem.

8. The information processing device according to claim 5, wherein the second storage unit is a storage unit which stores the program during start processing,
the information processing device further comprising:
a release section which releases a region of the second storage unit where the program is stored after the program stored in the second storage unit during the start processing is executed during the start processing.

9. A suspending/resuming method of an information processing device which is configured to execute suspending and resuming, the method comprising:
storing, in a second storage unit, a program stored in a first storage unit to initialize a display controller during the suspending; and
executing the program stored in the second storage unit during the resuming.

10. The suspending/resuming method of the information processing device according to claim 9, wherein an operation speed of the second storage unit is higher than that of the first storage unit.

11. The suspending/resuming method of the information processing device according to claim 9, further comprising:
judging during the resuming whether or not the program stored in the second storage unit has a problem; and
storing, in the second storage unit, the program stored in the first storage unit in a case where, during the judging, it is judged that the program has the problem.

12. The suspending/resuming method of the information processing device according to claim 9, further comprising:
storing, in the second storage unit, the program stored in the first storage unit during start processing;
executing, during the start processing, the program stored in the second storage unit during the start processing; and
releasing a region of the second storage unit in which the program is stored after the program is executed.
